(19) United States
(12) Patent Application Publication
(10) Pub. No.: US 2025/0262549 A1
(43) Pub. Date: Aug. 21, 2025

(54) COMPUTER SYSTEM AND GAME SYSTEM

(71) Applicant: BANDAI NAMCO ENTERTAINMENT INC., Tokyo (JP)

(72) Inventor: Kohei IKEDA, Kawasaki-shi (JP)

(73) Assignee: BANDAI NAMCO ENTERTAINMENT INC., Tokyo (JP)

(21) Appl. No.: 19/196,903

(22) Filed: May 2, 2025

Related U.S. Application Data
(63) Continuation of application No. 17/159,323, filed on Jan. 27, 2021, now abandoned.

(30) Foreign Application Priority Data
Feb. 3, 2020 (JP) 2020-016003

(51) Int. Cl. A63F 13/798; A63F 13/58; A63F 13/795

(52) U.S. Cl. CPC A63F 13/798; A63F 13/58; A63F 13/795; A63F 2300/5566; A63F 2300/558

(57) ABSTRACT

A server system includes a server storage section that stores match information including types of characters used in a match and a match result of the match for each match. The server system also includes a general value calculation section that calculates a general compatibility value between characters for each combination of characters based on the match information, an individual value calculation section that calculates an individual compatibility value between characters based on the match information on each match performed by an analysis target player, and a comparison display control section that performs a control of a list comparison display that compares the general compatibility value and the individual compatibility value of a same combination of characters.

This application is a continuation of U.S. application Ser. No. 17/159,323, filed Jan. 27, 2021, which is based upon and claims the benefit of priority to Japanese Patent Application No. 2020-016003 filed on Feb. 3, 2020, the entire contents of each of which is incorporated herein by reference.

### BACKGROUND

There have been games providing fun for a player operating a character to have a match with an opponent character. (See Japanese Unexamined Patent Application Publication No. 2004-24360, for example.) In this kind of games, the player usually selects a character to use for a match from limited characters, and thus the player needs to consider which character to use. For example, in order to select a character as a favorite (often-used) character, the player considers an appearance of each character as a matter of course. In addition, since each character has a favorite action and an unfavorite action, the player also considers an effect of each action, easiness of operation input for causing a character to perform an action, or the like. In view of this, in some game systems each including a game device and a server system communicably connected to each other, the server system acquires match results from the game device, and aggregates and analyzes compatibility values indicating match compatibility between characters focusing on the characters across all players. The analyzed compatibility values between characters are disclosed as service provided by a game provider.

However, the compatibility values conventionally disclosed are merely winning rates or the like between characters obtained as the compatibility values from past match results aggregated across all players. Accordingly, for example, a problem may occur if a beginner player selects a character a as his/her favorite character just because the disclosed compatibility value is high. For example, the problem occurs when a play skill is required for efficiently using the character a, and players who have actually used the character a are all skilled players. This is because the disclosed compatibility value is an average of the past match results of all players who have used the character a.

### BRIEF DESCRIPTION OF THE DRAWINGS

FIG. 1 is a diagram illustrating an example of a whole configuration of a game system.

FIG. 2 is a diagram illustrating an example of a device configuration of a player terminal.

FIG. 3 is a diagram illustrating an example of a data configuration of one piece of match information.

FIG. 4 is a diagram illustrating an example of a data configuration of a general compatibility value table.

FIG. 5 is a diagram illustrating an example of a data configuration of one individual compatibility value table.

FIG. 6 is a diagram illustrating an example of a data configuration of one comparison value table.

FIG. 7 is a diagram illustrating an example of a general value display screen.

FIG. 8 is a diagram illustrating an example of an individual value display screen.

FIG. 9 is a diagram illustrating an example of a display focusing on a single cell in relation to an individual value display in accordance with a modification example.

FIG. 10 is a diagram illustrating an example of a general value list comparison display.

FIG. 11 is a diagram illustrating an example of a data configuration of general value comparison data.

FIG. 12 is a diagram illustrating an example of an effect display before a player has a match in playing a game.

FIG. 13 is a block diagram illustrating an example of a functional configuration of a server system.

FIG. 14 is a diagram illustrating an example of programs and data stored in a server storage section.

FIG. 15 is a block diagram illustrating an example of a functional configuration of the player terminal.

FIG. 16 is a flowchart illustrating a flow of processes in the server system.

### DESCRIPTION OF EXEMPLARY EMBODIMENTS

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising:
at least one processor or circuit programmed to:
store match information including types of characters used in a match and a match result of the match for each match;
calculate an index value indicating match compatibility between characters as a general compatibility value for each combination of characters based on the match information;
calculate an index value indicating match compatibility between characters as an individual compatibility value for each combination of a character used by a first analysis target player in a match and a character used as an opponent of the character based on the match information on each match performed by the first analysis target player; and
perform a control of a list comparison display that compares the general compatibility value and the individual compatibility value of a same combination of characters.

As a result, in some embodiments, the general compatibility value between characters is calculated for each combination of characters usable in a match from the match result in the past, and the individual compatibility value between characters is calculated from the match result of the first analysis target player, so that the control of the list comparison display that compares the general compatibility value and the individual compatibility value of each same combination of characters can be performed. As a result, in some embodiments, the general compatibility value between characters can be presented to the player in a comparable manner with respect to the individual compatibility value of the same combination of characters based on the match result of the first analysis target player.

In accordance with one of some embodiments, there may be provided the computer system, wherein calculation of the individual compatibility value includes calculating an individual compatibility value based on a piece of match information that meets a predetermined aggregation target condition out of the match information on each match performed by the first analysis target player.

As a result, in some embodiments, the individual compatibility value can be calculated by selecting and using the piece of match information that meets the aggregation target condition from the match information of the first analysis target player.

In accordance with one of some embodiments, there may be provided the computer system, wherein the aggregation target condition includes at least that a number of matches performed with the same combination of the character used by the first analysis target player and the character used as the opponent meets a predetermined smallest match number condition.

As a result, in some embodiments, the individual compatibility value can be calculated when a number of pieces of match information that the first analysis target player uses the same character against the same opponent character in the match is equal to or larger than a predetermined number, for example.

In accordance with one of some embodiments, there may be provided the computer system, wherein the aggregation target condition includes at least that an index value indicating strength set to the opponent meets a predetermined lowest condition.

As a result, in some embodiments, the individual compatibility value can be calculated using the match information including the opponent whose index value indicating the strength is equal to or higher than a predetermined value, for example.

In accordance with one of some embodiments, there may be provided the computer system, wherein the control of the list comparison display includes performing a control of displaying the individual compatibility value and the general compatibility value together.

As a result, in some embodiments, the general compatibility value and the individual compatibility value of the same combination of characters can be displayed together in the list comparison display.

In accordance with one of some embodiments, there may be provided the computer system, wherein
calculation of the individual compatibility value includes calculating an individual compatibility value of a second analysis target player based on the match information on each match performed by the second analysis target player, and
the control of the list comparison display includes performing a control of a list comparison display that compares the individual compatibility value of the first analysis target player and the individual compatibility value of the second analysis target player.

As a result, in some embodiments, the individual compatibility value between characters is calculated from the match result of the second analysis target player, so that the control of the list comparison display that compares the individual compatibility value of the first analysis target player and the individual compatibility value of the second analysis target player of each same combination of characters can be performed. As a result, in some embodiments, the individual compatibility value between characters based on the match result of the second analysis target player can be presented to the player in a comparable manner with respect to the individual compatibility value of the same combination of characters based on the match result of the first analysis target player.

In accordance with one of some embodiments, there may be provided the computer system, wherein the control of the list comparison display includes performing a control of a list comparison display using cells formed in a matrix form divided for each combination of characters.

As a result, in some embodiments, a comparison result between the general compatibility value and the individual compatibility value of each combination of characters is displayed in a corresponding cell in the matrix form divided for each combination of characters, so that the list comparison display can be performed in relation to the first analysis target player.

In accordance with one of some embodiments, there may be provided the computer system, wherein the control of the list comparison display includes
performing a control of a list comparison display using cells formed in a matrix form divided for each combination of characters, and
performing a display control representing that the individual compatibility value is not calculated yet on a cell corresponding to a combination of characters that does not meet the aggregation target condition and whose individual compatibility value is not calculated yet, and
the at least one processor or circuit is further programmed to
perform a control of giving a given reward to the first analysis target player when the individual compatibility value is calculated in relation to the combination of characters whose individual compatibility value is not calculated.

As a result, in some embodiments, a comparison result between the general compatibility value and the individual compatibility value of each combination of characters is displayed in a corresponding cell in the matrix form divided for each combination of characters, so that the list comparison display can be performed in relation to the first analysis target player. In addition, when the individual compatibility value is calculated in a cell whose value has not been calculated in relation to the first analysis target player, the given reward can be given to the first analysis target player. As a result, in some embodiments, since the reward is given when the player performs matches using various characters against different opponent characters, the player can be motivated to select and use characters that the player has never selected and used before.

In accordance with one of some embodiments, there may be provided the computer system, wherein the control of the list comparison display includes performing a control of displaying a display body according to a comparison result between the general compatibility value and the individual compatibility value in a superimposing manner in each cell.

As a result, in some embodiments, the display body is displayed in each cell in the matrix form in the superimposing manner according to the comparison result between the general compatibility value and the individual compatibility value of a corresponding combination of characters, so that the list comparison display can be performed in relation to the first analysis target player.

In accordance with one of some embodiments, there may be provided the computer system, wherein the control of the list comparison display includes performing a control of variably displaying a display mode of each cell according to a comparison result between the general compatibility value and the individual compatibility value.

As a result, in some embodiments, the display mode of each cell in the matrix form is changed based on the comparison result between the general compatibility value and the individual compatibility value of each corresponding combination of characters, so that the list comparison display can be performed in relation to the first analysis target player.

In accordance with one of some embodiments, there may be provided the computer system, wherein the control of the list comparison display includes variably setting a display order of the cells in the matrix form based on a given display order rule.

As a result, in some embodiments, the display order of the cells in the matrix form can be changed.

In accordance with one of some embodiments, there may be provided the computer system, wherein the at least one processor or circuit is further programmed to
perform a control of implementing an effect based on any one of the general compatibility value, the individual compatibility value, and a comparison result between the general compatibility value and the individual compatibility value before or after the first analysis target player has a match in playing a game.

As a result, in some embodiments, the effect can be implemented before or after the first analysis target player has the match in playing the game based on any one of the general compatibility value, individual compatibility value, and comparison result between the general compatibility value and the individual compatibility value of the same combination of characters as the combination in the present match, for example.

In accordance with one of some embodiments, there may be provided the computer system, wherein the at least one processor or circuit is further programmed to
perform a control of implementing an effect based on any one of the general compatibility value, the individual compatibility value, and a comparison result between the general compatibility value and the individual compatibility value during a replay display of a game played by the first analysis target player.

As a result, in some embodiments, the effect can be implemented during the replay display of the game played by the first analysis target player based on any one of the general compatibility value, individual compatibility value, and comparison result between the general compatibility value and the individual compatibility value of the same combination of characters as the combination in the present match, for example.

In accordance with one of some embodiments, there is provided a computer system comprising:
at least one processor or circuit programmed to:
store match information including types of characters used in a match and a match result of the match for each match;
calculate an index value indicating match compatibility between characters as an individual compatibility value for each combination of a character used by an analysis target player in a match and a character used as an opponent of the character based on the match information on each match performed by the analysis target player; and
perform a control of a list comparison display that compares an initial compatibility value and a corresponding individual compatibility value of a same combination of characters.

As a result, in some embodiments, the individual compatibility value between characters is calculated from the match result of the analysis target player, so that the control of the list comparison display that compares the individual compatibility value and initial compatibility value of each same combination of characters can be performed. As a result, in some embodiments, the initial compatibility value between characters can be presented to the player in a comparable manner with respect to the individual compatibility value of the same combination of characters based on the match result of the analysis target player.

In accordance with one of some embodiments, there is provided a game system comprising:
a player terminal of each player; and
a server system that is the computer system as defined in claim 1 that is communicably connected to the player terminal.

Exemplary embodiments are described below. Note that the following exemplary embodiments do not in any way limit the scope of the content defined by the claims laid out herein. Note also that all of the elements described in the present embodiment should not necessarily be taken as essential elements.

Preferred embodiments of the present disclosure are hereinafter described referring to the drawings. However, the present disclosure is not limited by the following embodiments, and the modes to which the present disclosure is applicable are not limited to the following embodiments. In addition, common referential numerals are given to identical components in the drawings.

### [Whole Configuration]

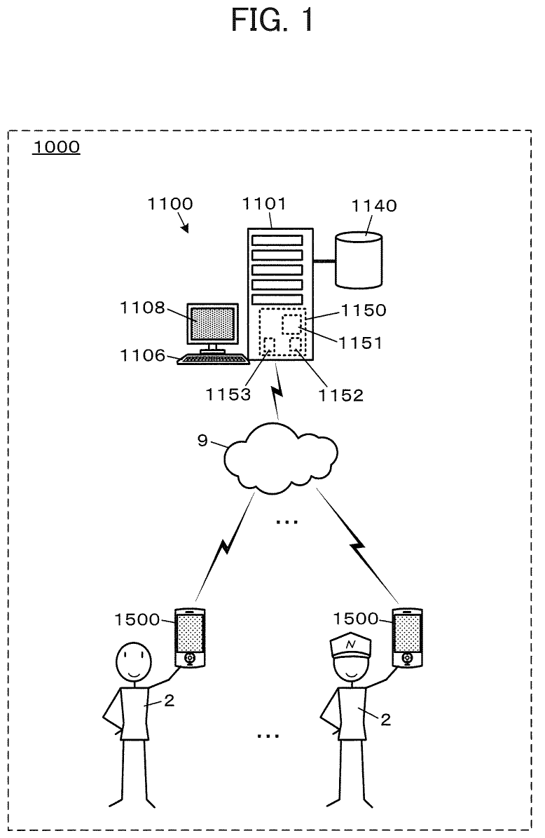

FIG. 1 is a diagram illustrating an example of a whole configuration of a game system 1000 in accordance with the present embodiment. As illustrated in FIG. 1, the game system 1000 includes a server system 1100 as a computer system and a player terminal 1500 possessed by a player (a user) 2 who plays a game in accordance with the present embodiment. The server system 1100 and the player terminal 1500 are connected to perform data communication with each other via a network 9. The game system 1000 may also be said as the computer system.

The network 9 is a communication channel capable of data communication. Specifically, the network 9 includes a communication network such as a local area network (LAN) using a private line (a private cable) for direct connection or Ethernet (registered trademark), a telecommunication network, a cable network, and an Internet. A communication method may be a cable communication method or a wireless communication method.

The server system 1100 includes a main body device 1101, a keyboard 1106, a touch panel 1108, and a storage 1140. The main body device 1101 includes a control board 1150 on which mounted are electronic components including a microprocessor of various types such as a central processing unit (CPU) 1151, a graphics processing unit (GPU), or a digital signal processor (DSP), an integrated circuit (IC) memory 1152 of various types such as a video random access memory (VRAM), a random access memory (RAM), or a read only memory (ROM), and a communication device 1153. The control board 1150 may be entirely or partially implemented by an application specific integrated circuit (ASIC), a field-programmable gate array (FPGA), or a system on a chip (SoC).

Through a calculation process performed by the CPU 1151 or the like based on a predetermined program and data, the server system 1100 implements a user management function related to user registration or the like and a game management function of providing data required to play the game with the player terminal 1500 to manage an execution control on the game played with the player terminal 1500. That is, the game in accordance with the present embodiment is implemented as a kind of client-server online game. The player 2 uses his/her own player terminal 1500 to access the server system 1100 and log in with an issued account (a player ID) to play the game in accordance with the present embodiment.

The server system 1100 is not limited to a single server configuration illustrated in FIG. 1, and may be configured such that a plurality of blade servers are connected via an internal bus to perform data communication to share the functions. Alternatively, the server system 1100 may be configured such that a plurality of independent server devices installed at separate places perform data communication via the network 9 to serve as the server system 1100 as a whole.

The player terminal 1500 is a computer system that functions as a man-machine interface, and connects to the network 9 via a mobile phone base station, a wireless communication base station, or the like to perform data communication with the server system 1100. The player terminal 1500 may be implemented as, for example, a smartphone, a mobile phone, a portable game device, a stationary consumer game device, a controller of the stationary consumer game device, an arcade game apparatus, a personal computer, a tablet computer, or a wearable computer.

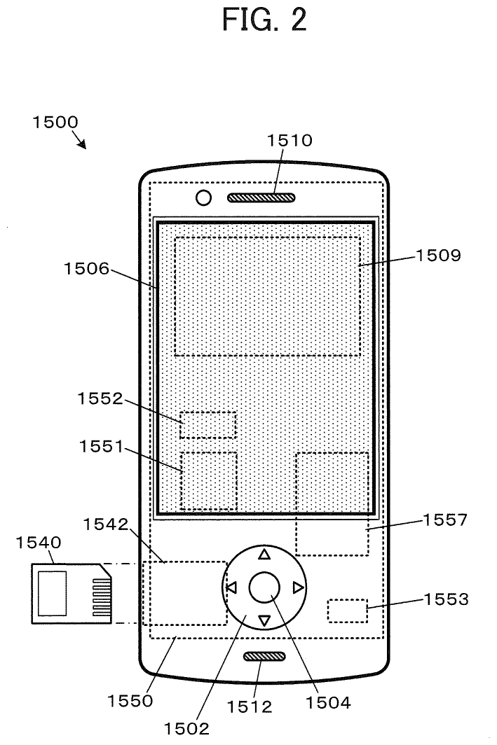

FIG. 2 is a diagram illustrating an example of a device configuration of a smartphone serving as the player terminal 1500. As illustrated in FIG. 2, the player terminal 1500 includes an arrow key 1502, a home key 1504, a touch panel 1506 that functions as an image display device and a touch position input device, a built-in battery 1509, a speaker 1510, a microphone 1512, a control board 1550, and a memory card reader 1542 that can write and read data on and from a memory card 1540 that is a computer readable storage medium. The player terminal 1500 further includes a power button, a volume control button, or the like (not illustrated).

The control board 1550 includes, for example, a microprocessor of various types such as a CPU 1551, a GPU, or a DSP, an IC memory 1552 of various types such as a VRAM, a RAM, or a ROM, and a wireless communication module 1553 for performing wireless communication with a mobile phone base station, a wireless LAN base station, or the like connected to the network 9. The control board 1550 includes so-called I/F circuits (interface circuits) 1557 including a circuit that receives signals from the arrow key 1502 and the home key 1504, a driver circuit for the touch panel 1506, an output amplifier circuit that outputs a sound signal to the speaker 1510, an audio signal generation circuit that generates a signal corresponding to the sound collected by the microphone 1512, and a signal input-output circuit that inputs and outputs a signal to and from the memory card reader 1542. These elements included in the control board 1550 are electrically connected through a bus circuit or the like so that the elements can read and write data and exchange signals. The control board 1550 may partially or entirely be implemented with an ASIC, an FPGA, or an SoC.

The IC memory 1552 in the control board 1550 stores, for example, a game client program and various types of setting data required to execute the game client program. The game client program or the like is downloaded from the server system 1100 at an appropriate timing. Alternatively, the game client program or the like may be read out from a storage medium such as the memory card 1540 separately provided. The CPU 1551 or the like executes the game client program to perform a calculation process, and controls each section of the player terminal 1500 to enable gameplay of the player 2 in accordance with an operation input with the touch panel 1506, the arrow key 1502, and the home key 1504.

### [Details]

The game in accordance with the present embodiment is a match-type fighting game enjoyed by a player who operates a player character to cause the player character to perform attack actions such as punching or kicking and defense actions such as guarding against attacks from an opponent in a match. The opponent is a player character operated by another player, but may be a computer-controlled character (a non-player character [NPC]). Each player selects a character to use for playing from a predetermined character group (hereinafter referred to as a “candidate character group”) including a plurality of types of characters selectable as a player character.

The server system 1100 aggregates and analyzes match results of played games to present a result to the player. For example, the result of the aggregation and analysis is disclosed on a website (a game site) provided by the server system 1100. The player accesses the game site with his/her player terminal 1500 and logs in with a previously issued player ID or the like to see details of the disclosure.

In accordance with the present embodiment, the server system 1100 stores and aggregates match information including types of characters used in a match and a match result of the match for each match. Then, the server system 1100 calculates a general compatibility value from the match information (a general value calculation process), calculates an individual compatibility value of a player who is an analysis target player (a first analysis target player) (an individual value calculation process), calculates a difference between the general compatibility value and the individual compatibility value (a comparison value calculation process), and performs a control of displaying the individual compatibility value in a comparable manner with respect to the general compatibility value (a comparison display control process). Furthermore, in accordance with the present embodiment, the server system 1100 performs a control of giving a given reward to the player according to the calculation of the individual compatibility value in the individual value calculation process (a reward giving control process), and a control of implementing an effect based on a comparison result between the general compatibility value and the individual compatibility value before gameplay by the player (an effect control process).

### (1) Match Information

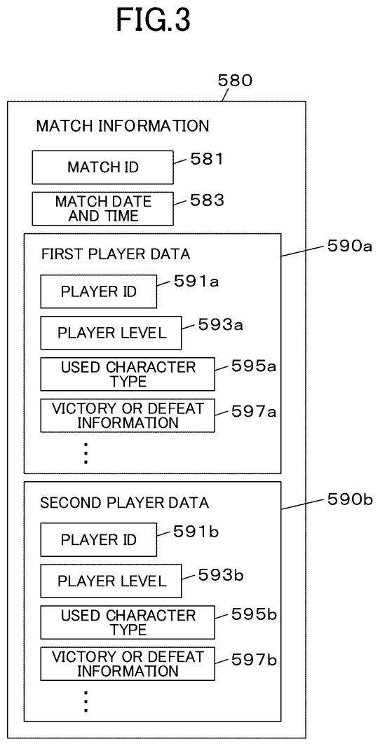

The server system 1100 generates and stores match information on each match whenever players have a match. FIG. 3 is a diagram illustrating an example of a data configuration of one piece of match information 580. As illustrated in FIG. 3, the match information 580 includes a unique match ID 581, a match date and time 583, first player data 590a of a first player who is one of players in a match, and second player data 590b of a second player who is another one of the players in the match.

The first player data 590a includes a player ID 591a of the first player, a player level 593a, a character type (a used character type) 595a used by the first player in the match, and victory or defeat information 597a. Similarly, the second player data 590b includes a player ID 591b of the second player, a player level 593b, a used character type 595b used by the second player in the match, and victory or defeat information 597b. The victory or defeat information 597a and 597b of the first player data 590a and the second player data 590b each includes flag information on whether the player has won as a match result of the match.

As will be described later in detail, in accordance with the present embodiment, a winning rate between the characters is calculated as the general compatibility value and the individual compatibility value based on the victory or defeat information 597a and 597b of the match result. However, the match information 580 may also include a physical strength gauge value at an end of a game, a remaining time at an end of a game when a limited time period is set for a match, or the like, as the match result. In this case, the match results can be aggregated and analyzed including, for example, whether the match has been an intense competition on both sides, or whether the match has been an overwhelming victory of a winning side, as well as the victory or defeat of the match, so as to calculate the general compatibility value and the individual compatibility value.

### (2) General Value Calculation Process

In the general value calculation process, an index value indicating match compatibility between characters is calculated as a general compatibility value for each combination of characters included in a candidate character group based on match information 580. In accordance with the present embodiment, the general value calculation process is performed when one game ends and new match information 580 is generated. As for procedures, processes described below are performed with a combination of characters that have fought in a latest game as a calculation target combination.

First of all, a piece of match information 580 including the same combination of characters, identified by the used character types 595a and 595b, as the calculation target combination is extracted from the match information 580 that has been stored. Then, a winning rate of each character in the calculation target combination is calculated in accordance with the victory or defeat information 597a or 597b of the extracted match information 580 and the match information 580 on the latest match. That is, in the general value calculation process, the match result (victory or defeat) of the latest match is reflected to the winning rate of each of the characters based on the match results of the matches between the same combination of characters performed by each player participating in the game (all registered users) in the past. Then, based on this, the general compatibility value is calculated for each character in the candidate character group with respect to each opponent character.

Accordingly, for example, when the general compatibility value of a character A with respect to a character B is high, the character A has a higher winning rate in the matches with this combination. Thus, the character A tends to be stronger in the matches with this combination in general (the character A has good compatibility with the character B). On the contrary, when the general compatibility value is low, the winning rate is low, and thus the character B tends to be stronger in general (the character B has good compatibility with the character A).

The general value calculation process does not need to be performed for each generation of the match information 580, and may be performed at a predetermined timing such as at a predetermined time or the like. Furthermore, a match between the same characters always ends in a draw, and thus the general compatibility value is not calculated.

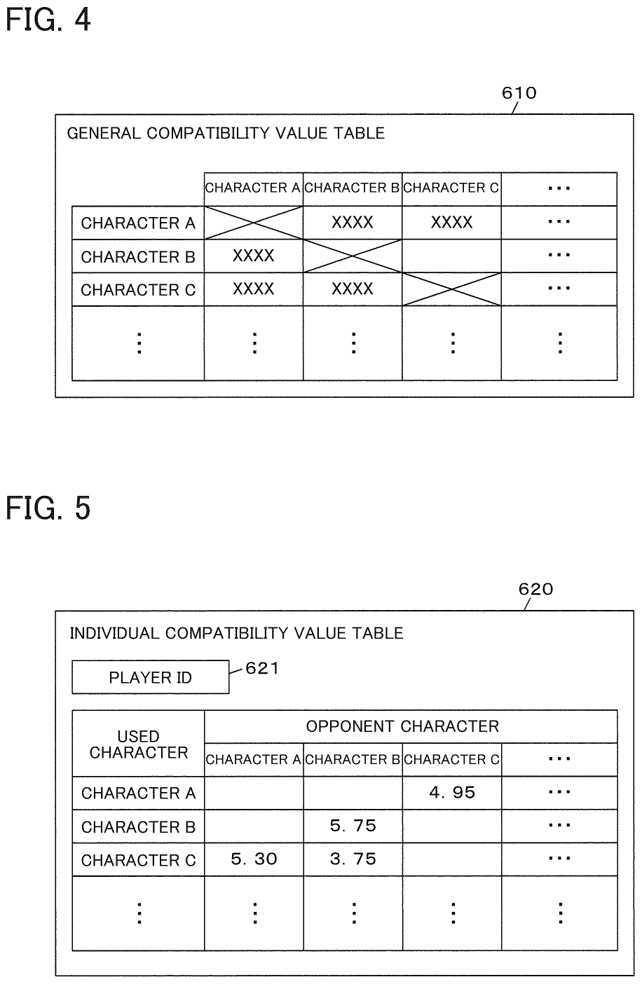

The general compatibility value calculated in the general value calculation process is stored in a general compatibility value table. FIG. 4 is a diagram illustrating an example of a data configuration of a general compatibility value table 610. As illustrated in FIG. 4, the general compatibility value table 610 stores latest general compatibility values of respective characters in the candidate character group vertically listed in a leftmost column (a vertical axis) with respect to respective characters in the candidate character group horizontally listed on a top row (a horizontal axis).

### (3) Individual Value Calculation Process

In the individual value calculation process, an index value indicating match compatibility between characters is calculated as an individual compatibility value for each combination of a character used by an analysis target player in each match and a character used as an opponent of the character in each match based on match information 580 of each match performed by the analysis target player.

In accordance with the present embodiment, the individual value calculation process is performed when one game ends and new match information 580 is generated. As for procedures, processes described below are performed by sequentially setting a first player and a second player in the ended game as the analysis target players.

First of all, the first player is set as the analysis target player. Then, a piece of match information 580 on a match that the first player uses the same used character as that in the latest match to fight against the same opponent character as that in the latest match is extracted as the match information 580 of an aggregation target (hereinafter referred to as “target match information”) from the match information 580 that has been stored. This can be implemented by extracting a piece of match information 580 that the player ID of the first player is set as any one of the player IDs 591a and 591b, the used character type of the latest match is set as corresponding one of the used character types 595a and 595b, and the opponent character type is set as another one of the used character types 595a and 595b.

Then, a winning rate of the used character of the first player with respect to the opponent character is calculated in accordance with the victory or defeat information 597a or 597b of both the extracted target match information 580 and the match information 580 of the latest match.

Next, the second player is set as the analysis target player. Then, target match information 580 is extracted in the same manner, and a winning rate of the used character of the second player with respect to the opponent character is calculated.

That is, in the individual value calculation process, the match result of the latest match is reflected to the winning rate of the used character with respect to the opponent character based on the match results of the matches performed by the first player in the past between the same used character and opponent character as those in the latest match. Similarly, the match result of the latest match is reflected to the winning rate of the used character with respect to the opponent character based on the match results of the matches performed by the second player in the past between the same used character and opponent character as those in the latest match. Then, based on this, the individual compatibility value is calculated for each character in the candidate character group with respect to each opponent character for each player participating in the game.

Accordingly, for example, when the individual compatibility value of a character A with respect to a character B calculated for a certain player is high, a winning rate of the matches that have been performed by the player using the character A against the character B is high. Thus, the player is good at (has good compatibility with) the match using the character A against the character B. On the contrary, when the individual compatibility value is low, the winning rate is low, and thus the player is not good at (has poor compatibility with) the match using the character A against the character B.

In the individual value calculation process, the winning rate is calculated for each player. Unlike the case of the general compatibility value, the individual compatibility value is calculated for a match between the same characters.

The individual compatibility value calculated in the individual value calculation process is stored in an individual compatibility value table for each player. FIG. 5 is a diagram illustrating an example of a data configuration of one individual compatibility value table 620. As illustrated in FIG. 5, the individual compatibility value table 620 includes used characters on a vertical axis and opponent characters on a horizontal axis, and stores latest individual compatibility values between corresponding characters in relation to a player of a player ID 621.

As described above, the individual compatibility value is calculated as the winning rate for each character used by the player in a past match with respect to an opponent character. Accordingly, the individual compatibility value is not calculated for a character that has not been used by the player in any match, and a corresponding cell in the individual compatibility value table 620 is blank. In addition, even when the character has been used, the individual compatibility value with respect to an opponent character that has not been engaged in a match is not calculated, and thus a corresponding cell is also blank. However, unlike the general compatibility value, the individual compatibility value is calculated between the same characters if these characters have a match. When the player uses characters in the candidate character group evenly and thoroughly to repeatedly fight against different characters, blank cells in the individual compatibility value table 620 are filled in. In the reward giving control process described later, a reward is given to the player who has performed a match to fill in a blank cell.

In the individual value calculation process described above, the first player and the second player are sequentially set as the analysis target players, and a piece of match information 580 including the same combination of a used character and an opponent character as that in the latest match is simply extracted from the match information 580 of the matches performed by the analysis target player as the target match information 580. However, a piece of match information 580 that meets a predetermined aggregation target condition may be selected from extracted pieces of match information 580 as the target match information 580.

For example, the aggregation target condition may be that “a total number of pieces of match information 580 obtained by adding a latest piece of match information 580 to extracted pieces of match information 580 meets a predetermined smallest match number condition”. Assume that the smallest match number condition is specifically defined as “ten or more”. When a number of corresponding pieces of match information 580 is ten or more, these pieces are selected as the target match information 580. When the number is smaller than ten, these pieces are not selected as the target match information 580, and the individual compatibility value is not calculated.

Furthermore, the aggregation target condition may be that “an index value indicating strength set to an opponent meets a predetermined lowest condition”. For example, when the index value indicating the strength is the player level, and the lowest condition is defined as a lower limit value of the player level, a piece of match information 580 that a value of the player level 593a or 593b of the opponent is equal to or higher than the lower limit value is selected from the extracted pieces of match information 580 as the target match information 580.

Alternatively, when a character level is set to each character in the candidate character group, the index value indicating the strength may be the character level and the lowest condition may be defined as a lower limit value of the character level. The character level may be a fixed value set to each character, or a variable value that varies by use in a match by a player. In the latter case, the value of the character level at a time of a match is stored in the match information 580. Then, a piece of match information 580 that the value of the character level of the opponent is equal to or higher than the lower limit value is selected from the extracted pieces of match information 580 as the target match information 580.

The character level may be a variable value that varies in a game mode different from the match. For example, the value may vary in story mode play in which a story progresses by completing predetermined missions, or may vary by reinforcement of a character, fusion of a character, or the like. Furthermore, in a configuration with a variable character level, an ability parameter value such as fighting strength or defensive strength of a character may vary according to a character level of the character.

The aggregation target condition may also be that “a difference between player levels of players in a match is within a predetermined range”, or that “a difference between character levels of characters used in a match is within a predetermined range”, and a corresponding piece of match information 580 may be selected from the extracted pieces of match information 580 as the target match information 580. In these cases, a piece of match information 580 on a match between players with close player levels, or a piece of match information 580 on a match between characters with close character levels can be selected as the target match information 580. As a result, an individual index value can be calculated from the match result of the match performed in a situation where abilities of the players or the characters are close.

Furthermore, two or more of the aggregation target conditions described above may be combined, and a piece of match information 580 that meets all these aggregation target conditions may be selected. For example, when there are ten or more pieces of match information 580 that a difference between the player levels is within a predetermined range, these pieces are selected as the target match information 580.

### (4) Comparison Value Calculation Process

In the comparison value calculation process, a difference between a general compatibility value calculated in the general value calculation process and an individual compatibility value calculated in the individual value calculation process is calculated as a comparison value. In accordance with the present embodiment, when one game ends and new match information 580 is generated, a general compatibility value is calculated for each character that has fought in the game with respect to the opponent in the general value calculation process, and a corresponding individual compatibility value is calculated in the individual value calculation process. In the comparison value calculation process, a difference between the general compatibility value and the individual compatibility value of each character with respect to the opponent is calculated.

Specifically, the comparison value is obtained by subtracting the general compatibility value from the individual compatibility value. Accordingly, when the individual compatibility value is higher, i.e., when the winning rate between the characters calculated from the match information 580 on the matches performed by the analysis target player (the first player or the second player) is higher than the winning rate between the characters calculated from the entire match information 580, the comparison value is a positive value. On the contrary, when the individual compatibility value is lower and the winning rate of the analysis target player is lower, the comparison value is a negative value. As for a cell between the same characters where the general compatibility value is not calculated, the general compatibility value is assumed to be 5.00 to calculate the comparison value.

The comparison value may be calculated as an increase/decrease rate (%) of the individual compatibility value with respect to the general compatibility value. For example, assume that there are two cases where the general compatibility value is 5.0 and the individual compatibility value is 5.1 and where the general compatibility value is 4.0 and the individual compatibility value is 4.1. The comparison value is 0.1 in both cases in a configuration obtaining the comparison value by subtracting the general compatibility value from the individual compatibility value, as described above. However, in a configuration obtaining the comparison value by the increase/decrease rate (%), the comparison value is 2% in the former case, and 2.5% in the latter case. Therefore, obtaining the comparison value by the increase/decrease rate (%) enables more accurate comparison between the general compatibility value and the individual compatibility value.

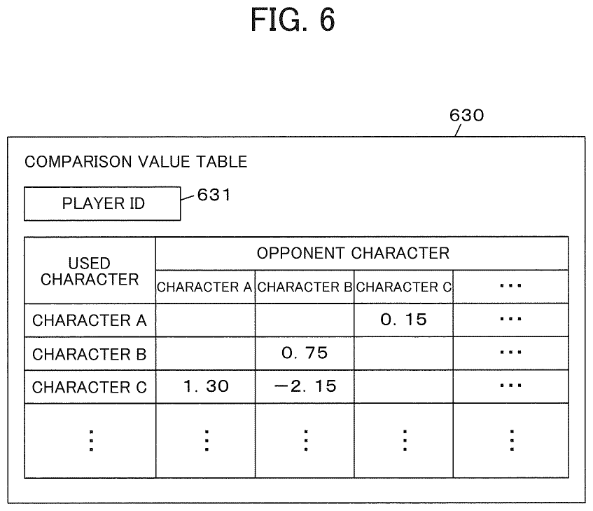

The comparison value calculated in the comparison value calculation process is stored in a comparison value table for each player. FIG. 6 is a diagram illustrating an example of a data configuration of one comparison value table 630. As illustrated in FIG. 6, the comparison value table 630 stores latest comparison values of respective characters (used characters) on a vertical axis with respect to respective characters (opponent characters) on a horizontal axis in relation to a player of a player ID 631.

### (5) Comparison Display Control Process

In the comparison display control process, a control of a list comparison display of various types in relation to an individual compatibility value of a player (hereinafter referred to as a “display target player”) is performed. A display of an aggregation and analysis result including the list comparison display is performed when a corresponding display menu is selected by the player who has logged in a game site. In accordance with the present embodiment, the server system 1100 controls a display based on general compatibility values (hereinafter referred to as a “general value display”) when a general value display menu is selected. When an individual value display menu is selected, the server system 1100 controls a display of individual compatibility values (hereinafter referred to as an “individual value display”) with a player who has made a selection operation as the display target player.

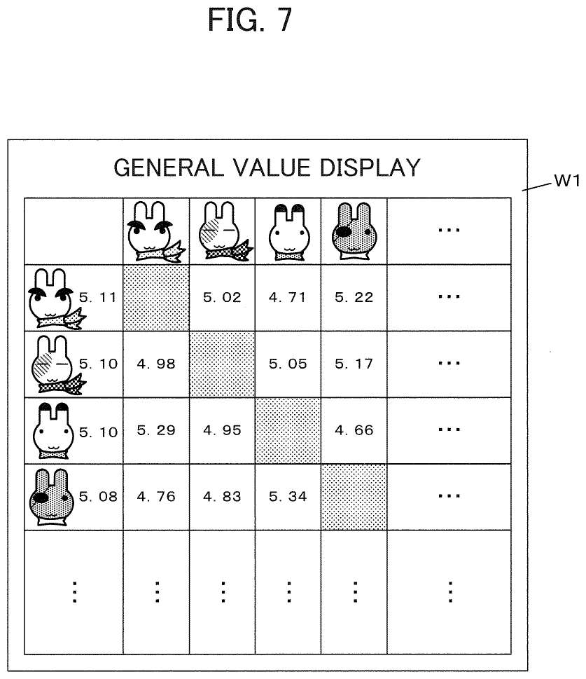

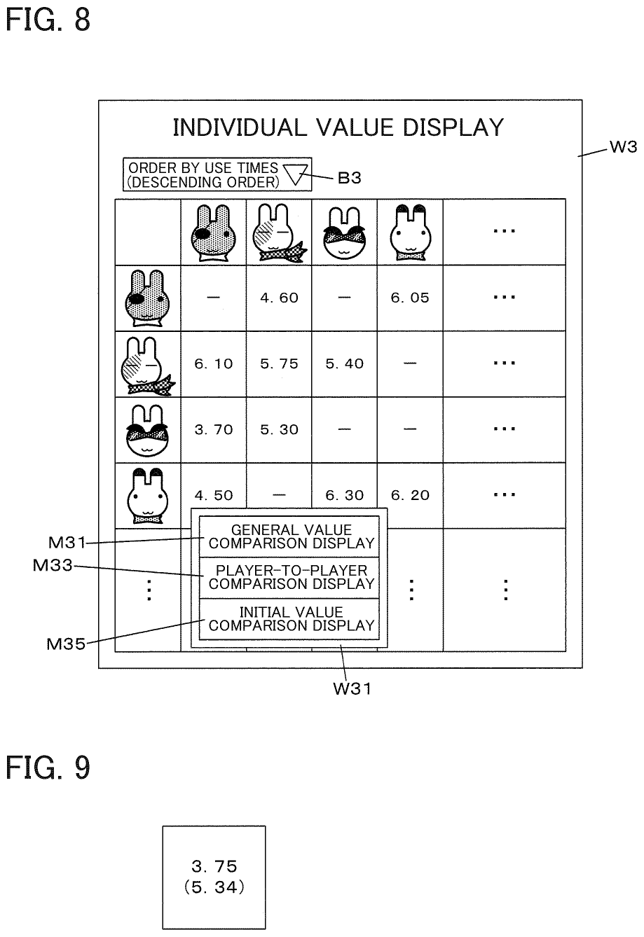

FIG. 7 is a diagram illustrating an example of a general value display screen, and FIG. 8 is a diagram illustrating an example of an individual value display screen W3. As illustrated in FIG. 7, the control of the general value display is performed using cells formed in a matrix form divided for each combination of characters in the candidate character group. Specifically, the general value display is performed by displaying each of the general compatibility values in the general compatibility value table 610 in a corresponding cell. In accordance with the present embodiment, the winning rate calculated from the match results of all players up to a time of the display is displayed as the winning rate of each character on a vertical axis with respect to each character on a horizontal axis. When there is a blank cell without a general compatibility value in the general compatibility value table 610 since no player has performed a match with a corresponding combination, a display control is performed by displaying a sign “-” in the cell so as to represent that the general compatibility value between these characters is not calculated yet.

A numerical value added to each character on the vertical axis is an average value of the general compatibility values displayed in the cells in a corresponding row (an average value of the general compatibility values of the character with respect to the characters on the horizontal axis).

On the other hand, the control of the individual value display is also performed using the similar cells in the matrix form as illustrated in FIG. 8. Specifically, the individual value display is performed by displaying each of the individual compatibility values in the individual compatibility value table 620 of the display target player in a corresponding cell. In accordance with the present embodiment, the winning rate calculated from the match results of the display target player up to a time of the display is displayed as the winning rate of each character on a vertical axis used by the display target player with respect to each character on a horizontal axis. When there is a blank cell without an individual compatibility value in the individual compatibility value table 620 since there is a character that has not been used by the display target player or a character that has not been an opponent of the display target player, a display control is performed by displaying a sign “-” in the cell so as to represent that the individual compatibility value between these characters is not calculated yet.

In the individual value display screen, a display order of the cells of each character may be variably set based on a given display order rule. For example, when a pull-down button B3 is operated by a touch operation, a list of display order rules is displayed as options. Then, in accordance with a selected display order rule, the display order of the cells on the vertical axis and the horizontal axis is rearranged.

The options of the display order rules include, for example, a display order rule that rearranges the cells in an ascending or descending order of a number of times that the display target player has used a certain character in the matches, a display order rule that rearranges the cells in an ascending or descending order of a number of times of victory (a number of victories) that the display target player using a certain character has won the matches, a display order rule that rearranges the cells in an ascending or descending order of average values of the individual compatibility values of the characters, and a display order rule that rearranges the cells in an ascending or descending order of the character levels of the characters.

Furthermore, the options may include a display order rule that rearranges the cells in an ascending or descending order of a number of times that a certain character has become an opponent in the matches performed by the display target player, and a display order rule that rearranges the cells in an ascending or descending order of a number of times of victory that a certain opponent character has won the matches performed by the display target player.

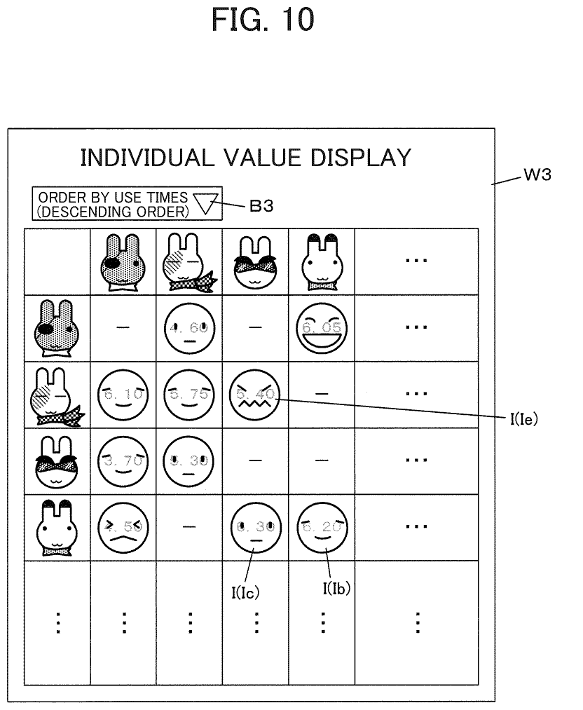

In the individual value display, a corresponding general compatibility value may also be displayed in a cell together. FIG. 9 is a diagram illustrating an example of a display focusing on a single cell in relation to the individual value display in accordance with a modification example. As illustrated in FIG. 9, the general compatibility value may be displayed below the individual compatibility value in a parenthesis, for example. As a result, the corresponding general compatibility value (the general compatibility value of the same combination of characters) can be simultaneously confirmed with the individual compatibility value on the individual value display screen.

Selection of a menu (a general value comparison display menu) M31 of a comparison display with the general compatibility value, a menu (a player-to-player comparison display menu) M33 of a comparison display with an individual compatibility value of another player, or a menu (an initial value comparison display menu) M35 of a comparison display with an initial compatibility value can be made in a menu window W31 displayed by a touch operation on a screen or the like during the control of the individual value display. Upon selection of a menu, a control of a corresponding list comparison display is performed.

First of all, when the general value comparison display menu M31 is selected, a control of a “general value list comparison display” is performed. In the general value list comparison display, the individual compatibility values of the display target player are compared with the general compatibility values. FIG. 10 is a diagram illustrating an example of the general value list comparison display. The general value list comparison display is performed using the comparison value table 630 of the display target player. A display body I according to a comparison value is displayed in a superimposing manner on each cell displaying an individual compatibility value. To do so, the display body I to be displayed in the superimposing manner is first determined for each comparison value set in the comparison value table 630.

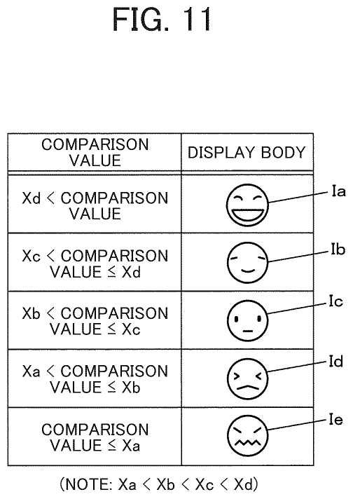

In accordance with the present embodiment, a plurality of types of display bodies I are prepared as face icons with different expressions, and correspondence relations with value ranges of the comparison values are previously set, for example. FIG. 11 is a diagram illustrating a setting example of the display bodies I (Ia to Ie) for the general value list comparison display. In the example in FIG. 11, an entire range of possible comparison values is divided into five value ranges, and the correspondence relation between each of the value ranges and display bodies I is set. More specifically, each of the display bodies I illustrated in FIG. 11 is a face icon with an expression that changes brighter as the comparison value is higher, and darker as the comparison value is lower.

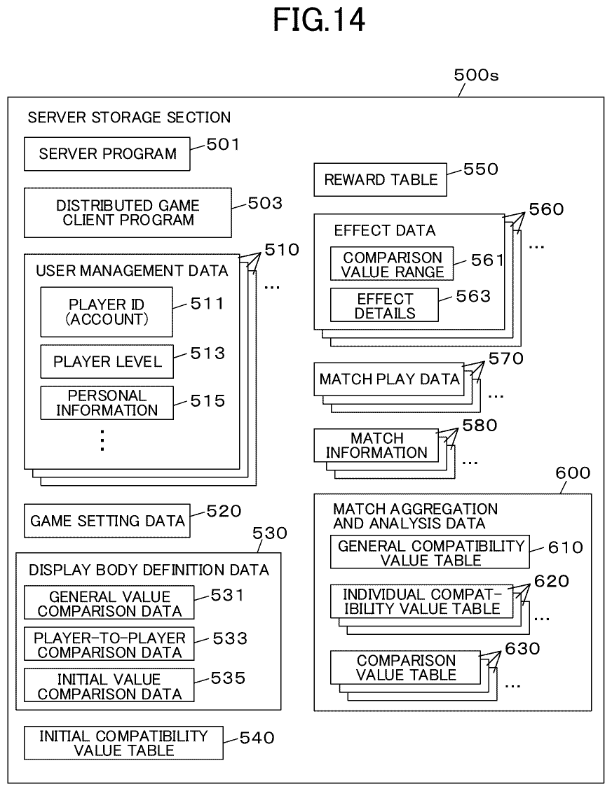

Then, a display body I is determined for each comparison value according to setting data (general value comparison data 531; see FIG. 14) of the display bodies I exemplified in FIG. 11. After this, the determined display body I is displayed in the superimposing manner on the individual compatibility value in the corresponding cell.

With this general value list comparison display, in each cell of the individual value display displaying the individual compatibility value between each combination of characters based on the match results of the player himself/herself, the player can grasp a comparison result with respect to the general compatibility value of the same combination of characters by the display of the display body I. That is, in addition to the individual compatibility value of the player himself/herself, the player can intuitively grasp whether the individual compatibility value is higher or lower than the general compatibility value by the expression of the display body I displayed in the same cell.

The display body only needs to be a display allowing an intuitive grasp of whether the individual compatibility value is higher or lower than the general compatibility value. For example, the display bodies may be weather mark icons such as a shiny mark, a cloudy mark, or a rainy mark, blooming mark icons indicating different degrees of blooming, or evaluation mark icons such as ∘, Δ, or x. Furthermore, types of the display body (the expression/weather mark/blooming mark/evaluation mark) may be changed according to age, sex, a residential area, or the like of the player.

Next, when the player-to-player comparison display menu M33 is selected, a control of a “player-to-player list comparison display” is performed. In the player-to-player list comparison display, the individual compatibility values of the display target player are compared with individual compatibility values of another player of a comparison target (hereinafter referred to as a “comparison target player”) who is a second analysis target player. The player-to-player list comparison display is performed on a cell displaying the individual compatibility value of the display target player by displaying a display body according to the corresponding individual compatibility value of the comparison target player in the superimposing manner.

To do so, when the player-to-player comparison display menu M33 is selected, a selection operation for selecting the comparison target player is subsequently accepted. Then, a player-to-player comparison value is calculated by subtracting the individual compatibility value in the individual compatibility value table 620 of the comparison target player from the corresponding individual compatibility value in the individual compatibility value table 620 of the display target player. Then, similarly to the control of the general value list comparison display, a control of displaying a display body according to a player-to-player comparison value is performed in the superimposing manner on each cell displaying the individual compatibility value.

Specifically, correspondence relations between value ranges of the player-to-player comparison values and display bodies are previously set as setting data (player-to-player comparison data 533; see FIG. 14) for the player-to-player list comparison display. Then, according to the player-to-player comparison data 533, a display body is determined for each of the calculated player-to-player comparison values, and is displayed in the superimposing manner on the individual compatibility value of the display target player in a corresponding cell.

With this player-to-player list comparison display, in each cell of the individual value display displaying the individual compatibility value between each combination of characters based on the match results of the player himself/herself, the player can grasp a comparison result with respect to the individual compatibility value of the same combination of characters in relation to designated another player by the display of the display body. That is, in addition to the individual compatibility value of the player himself/herself, the player can intuitively grasp whether the individual compatibility value is higher or lower than the individual compatibility value of another player by the expression of the display body displayed in the same cell.

Next, when the initial value comparison display menu M35 is selected, a control of an “initial value list comparison display” is performed. In the initial value list comparison display, the individual compatibility values of the display target player are compared with previously set initial compatibility values. The initial value list comparison display is performed on a cell displaying the individual compatibility value of the display target player by displaying a display body according to a corresponding initial compatibility value in the superimposing manner.

The initial compatibility value is a compatibility value set by previously estimating strength of characters for each combination of characters based on motion information set for each character or a stiff time (a required time to start a next motion after a certain motion) set for each motion, or the like. For example, similarly to the general compatibility value table 610, an initial compatibility value table 540 (see FIG. 14) that stores an initial setting value of each character in the candidate character group with respect to each opponent character is prepared.

Then, when the initial value comparison display menu M 35 is selected, an initial comparison value is calculated by subtracting the initial compatibility value in the initial compatibility value table 540 from the corresponding individual compatibility value in the individual compatibility value table 620 of the display target player. Then, similarly to the control of the general value list comparison display or the player-to-player list comparison display, a control of displaying a display body according to an initial comparison value is performed in the superimposing manner on each cell displaying the individual compatibility value.

Specifically, correspondence relations between value ranges of the initial comparison values and display bodies are previously set as setting data (initial value comparison data 535; see FIG. 14) for the initial value list comparison display. Then, according to the initial value comparison data 535, a display body is determined for each of the calculated initial comparison values, and is displayed in the superimposing manner on the individual compatibility value of the display target player in a corresponding cell.

With this initial value list comparison display, in each cell of the individual value display displaying the individual compatibility value between each combination of characters based on the match results of the player himself/herself, the player can grasp a comparison result with respect the initial compatibility value of the same combination of characters by the display of the display body. That is, in addition to the individual compatibility value of the player himself/herself, the player can intuitively grasp whether the individual compatibility value is higher or lower than the initial compatibility value by the expression of the display body displayed in the same cell.

### (6) Reward Giving Control Process

In the reward giving control process, a control of giving a given reward to the analysis target player is performed when an uncalculated individual compatibility value between characters is calculated in relation to the analysis target player (the first player and the second player who have finished the match in the present embodiment) in the individual value calculation process. That is, when an individual compatibility value between characters in a blank cell of the individual compatibility value table 620 is calculated due to a new match performed by the player, a reward is given to the player. Instead of or in addition to a case where the individual compatibility value between characters in the blank cell is calculated, a reward may be given when a comparison value becomes equal to or higher than a predetermined value as a result of update of the individual compatibility value.

Details of the reward is not specifically limited. The reward may be set as appropriate such as giving a game object such as a character or an item usable in the game, opening a new game stage or a map, executing a mini game, or a combination of them. The game object includes a character selectable as a player character, various kinds of items that a player character can possess or use such as a weapon, a protection, a bullet, or medicine, an additional ability that can be added to a player character such as a vehicle of a player character, a summoned beast, magic, or a skill, a right of lottery, or the like. The details of the reward may be variable according to a number of uncalculated individual compatibility values (a number of blank cells in the individual compatibility value table 620) at that point.

### (7) Effect Control Process

In the effect control process, a control of implementation of an effect for each player based on a comparison result between a general compatibility value and an individual compatibility value is performed on the player terminal 1500 of each player who is going to have a match before the player starts playing the game. As for the comparison result, a comparison value of a used character with respect to an opponent character may be used, for example. Specifically, first of all, a comparison value of a character used by the first player with respect to a character used by the second player is read out from the comparison value table 630 of the first player. Then, the control of the implementation of the effect for the first player is performed using the read-out comparison value on the player terminal 1500 of the first player.

The same process is also performed to the second player. A comparison value of the character used by the second player with respect to the character used by the first player is read out from the comparison value table 630 of the second player. Then, the control of the implementation of the effect for the second player is performed using the read-out comparison value on the player terminal 1500 of the second player.

For example, when the comparison value is high, a control of a display representing that the match is against a favorable (compatible) opponent for the first player, or that the first player has an advantage is performed to control the implementation of the effect. When the comparison value is low, a control of a display representing that the match is against an unfavorable (incompatible) opponent for the first player, or that the first player has a disadvantage is performed. When the comparison value is near zero and there is no or little difference between the winning rates of both players, a control of a display representing that the match is a close game is performed. The effect may be implemented by performing a control of outputting a sound according to the comparison value, as a matter of course.

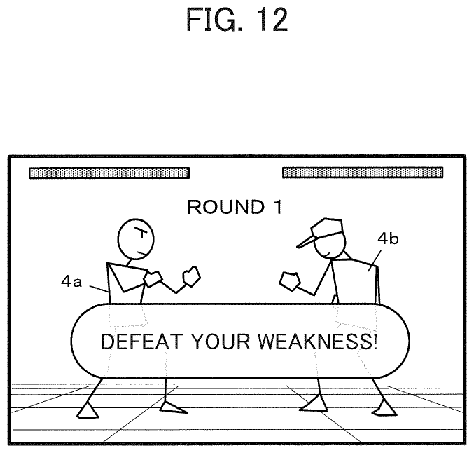

FIG. 12 is a diagram illustrating an example of an effect display. Specifically, FIG. 12 illustrates an example of the effect display for the first player displayed on the player terminal 1500 of the first player before gameplay of a match between a character 4a operated by the first player and a character 4b operated by the second player. That is, the example illustrates the effect display displayed when the comparison value of the character 4a with respect to the character 4b in relation to the first player is low (i.e., the individual compatibility value based on the match results of the matches performed by the first player using the character 4a against the character 4b is lower than the general compatibility value related to the same combination of characters), and a message representing that the match is against an unfavorable opponent is displayed.

The present embodiment is not limited to a configuration using the comparison value, and may have a configuration using the player-to-player comparison value. That is, a comparison value (a player-to-player comparison value) of the individual compatibility values between the characters in the match is obtained between the first player and the second player as described above, and an effect according to the calculated player-to-player comparison value may be implemented.

### [Functional Configuration]

### 1. Server System

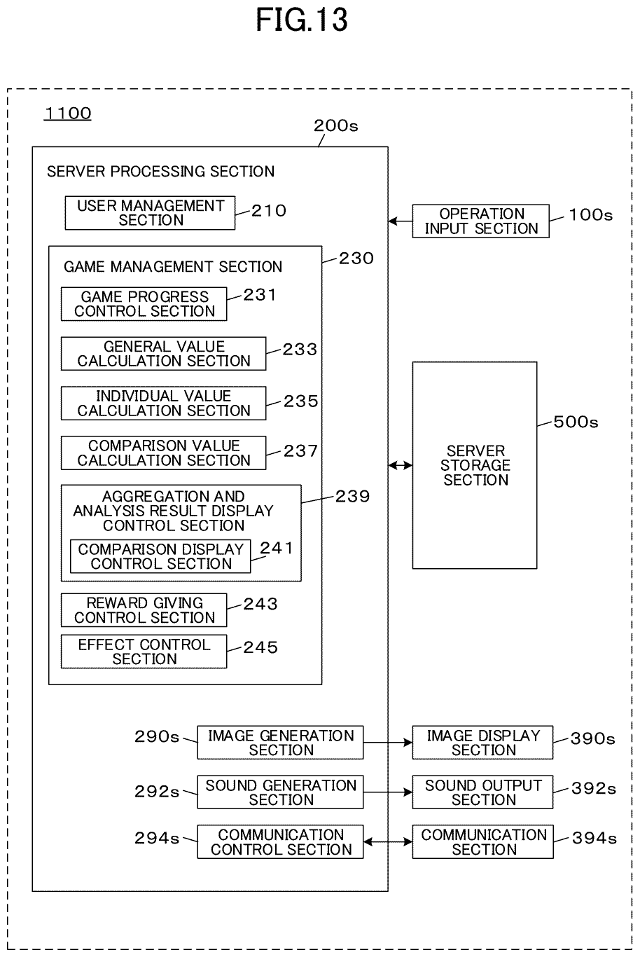

FIG. 13 is a block diagram illustrating an example of a functional configuration of the server system 1100. As illustrated in FIG. 13, the server system 1100 in accordance with the present embodiment includes an operation input section 100s, a server processing section 200s, an image display section 390s, a sound output section 392s, a communication section 394s, and a server storage section 500s.

The operation input section 100s is a means for inputting various operations for system management and maintenance, and can be implemented by, for example, a keyboard, a mouse, or a touch panel. The operation input section 100s corresponds to the keyboard 1106 and the touch panel 1108 illustrated in FIG. 1.

The server processing section 200s can be implemented, for example, by a processor including an arithmetic circuit such as a CPU, a GPU, an ASIC, or an FPGA, and an electronic component such as an IC memory. The server processing section 200s controls input/output of data between device sections including the operation input section 100s and the server storage section 500s. The server processing section 200s performs various calculation processes based on a predetermined program, data, an operation input signal from the operation input section 100s, and data received from the player terminal 1500 to integrally control the operation of the server system 1100. The server processing section 200s corresponds to the control board 1150 and the CPU 1151 thereon illustrated in FIG. 1.

The server processing section 200s includes a user management section 210, a game management section 230, an image generation section 290s, a sound generation section 292s, and a communication control section 294s.

The user management section 210 performs a process related to user registration and manages the data of each registered user (a player) associated with a player ID (an account). For example, the user management section 210 can perform an issuing process of issuing a unique player ID to the registered player, a registration information management process of registering and managing personal information for each player ID, and a play history management process of managing a history of login and logout or the like. Of course, any other management processes for other data associated with the player ID can be included as appropriate.

The game management section 230 performs various processes related to game execution management. The game in accordance with the present embodiment is a client-server online game, and thus the game management section 230 communicates with the player terminal 1500 to perform a control of providing data required for gameplay. The game management section 230 includes a game progress control section 231, a general value calculation section 233, an individual value calculation section 235, a comparison value calculation section 237, an aggregation and analysis result display control section 239, a reward giving control section 243, and an effect control section 245.

The game progress control section 231 communicates with the player terminal 1500 as needed to control progress of gameplay (a match) on the player terminal 1500, and performs a process related to a reflection of the gameplay.

The general value calculation section 233 is a functional section that performs the general value calculation process, and calculates a general compatibility value between characters for each combination of characters in a candidate character group based on the match information 580. In the present embodiment, a winning rate of each character in the candidate character group with respect to each opponent character is calculated as the general compatibility value.

The individual value calculation section 235 is a functional section that performs the individual value calculation process, and calculates an individual compatibility value between characters for each combination of a character and an opponent character based on the match information 580 on each match performed by an analysis target player. In the present embodiment, a winning rate of each character in a candidate character group with respect to each opponent character is calculated for each player as the individual compatibility value.

The comparison value calculation section 237 is a functional section that performs the comparison value calculation process, and calculates a difference between a general compatibility value and an individual compatibility value related to the same combination of characters as a comparison value for each character in a candidate character group.

The aggregation and analysis result display control section 239 performs a control related to a display of the general compatibility value calculated by the general value calculation section 233 and the individual compatibility value calculated by the individual value calculation section 235. In the present embodiment, the aggregation and analysis result display control section 239 performs a control of the general value display when the general value display menu is selected by a player (a display target player) who has accessed the game site, and performs a control of the individual value display when the individual value display menu is selected. Specifically, as described referring to FIGS. 7 and 8, the aggregation and analysis result display control section 239 controls the display of the general compatibility value and the display of the individual compatibility value of the display target player in relation to each character in the candidate character group on the vertical axis with respect to each character in the candidate character group on the horizontal axis, using the cells in the matrix form. Furthermore, the aggregation and analysis result display control section 239 rearranges the display order of the cells on the vertical axis and the horizontal axis in the matrix form of the individual value display when the pull-down button B3 (see FIG. 8) is operated by a touch operation to select a display order rule during the control of the individual value display.

The aggregation and analysis result display control section 239 also includes a comparison display control section 241 that performs the comparison display control process. The comparison display control section 241 performs the control of the general value list comparison display when the general value comparison display menu M31 (see FIG. 8) is selected during the control of the individual value display, the control of the player-to-player list comparison display when the player-to-player comparison display menu M33 (see FIG. 8) is selected, and the control of the initial value list comparison display when the initial value comparison display menu M35 (see FIG. 8) is selected.

The reward giving control section 243 is a functional section that performs the reward giving control process, and performs a control of giving a given reward to a player when an individual compatibility value of a player who is set as an analysis target player is calculated by the individual value calculation section 235, and the calculated individual compatibility value corresponds to an uncalculated individual compatibility value between characters in relation to the player.

The effect control section 245 is a functional section that performs the effect control process, and refers to the comparison value table 630 of a player to perform a control of implementing an effect based on a comparison value of a used character with respect to an opponent character before the player has a match in playing the game, for example.

The image generation section 290s generates images related to the system management of the server system 1100 or the like, and outputs the resultant to the image display section 390s.

The sound generation section 292s is implemented by execution of an IC or software for generating and decoding sound data, and generates or decodes sound data of operational sounds related to the system management of the server system 1100 and video distribution, and background music (BGM), for example. Sound signals related to the system management are output to the sound output section 392s.

The communication control section 294s performs communication connection and data processing for data communication with an external device (e.g., the player terminal 1500) through the communication section 394s to implement exchange of data with the external device.

The image display section 390s displays various screens for the system management based on the image signals input from the image generation section 290s. For example, the image display section 390s can be implemented by an image display device such as a flat panel display, a projector, or a head-mounted display. The image display section 390s corresponds to the touch panel 1108 illustrated in FIG. 1.

The sound output section 392s receives the sound signals input from the sound generation section 292s to emit corresponding sounds. The sound output section 392s corresponds to a speaker (not illustrated) included in the main body device 1101 or the touch panel 1108 in FIG. 1.

The communication section 394s connects to the network 9 to implement communication. For example, the communication section 394s can be implemented by a transceiver, a modem, a terminal adaptor (TA), a jack for wired communication cable, a control circuit, or the like. The communication section 394s corresponds to the communication device 1153 illustrated in FIG. 1.

The server storage section 500s stores programs for causing the server system 1100 to operate to implement various functions included in the server system 1100 and data used during execution of the programs. The programs and the data are stored previously or temporarily at every process. For example, the server storage section 500s can be implemented by an IC memory such as a RAM or a ROM, a magnetic disc such as a hard disc, or an optical disc such as a compact disc read-only memory (CD-ROM) or a digital versatile disc (DVD). The server storage section 500s corresponds to the IC memory 1152 and the storage 1140 illustrated in FIG. 1.

FIG. 14 is a diagram illustrating an example of programs and data stored in the server storage section 500s in accordance with the present embodiment. The server storage section 500s in accordance with the present embodiment stores a server program 501, a distributed game client program 503, user management data 510, game setting data 520, display body definition data 530, an initial compatibility value table 540, a reward table 550, effect data 560, match play data 570, the match information 580, and match aggregation and analysis data 600. The server storage section 500s may also store necessary data such as a timer, a counter, or various types of flags as appropriate.

The server program 501 is a program for causing the server processing section 200s to function as the user management section 210 and the game management section 230. The server program 501 may include programs for causing the server processing section 200s to function as the image generation section 290s, the sound generation section 292s, and the communication control section 294s as appropriate.

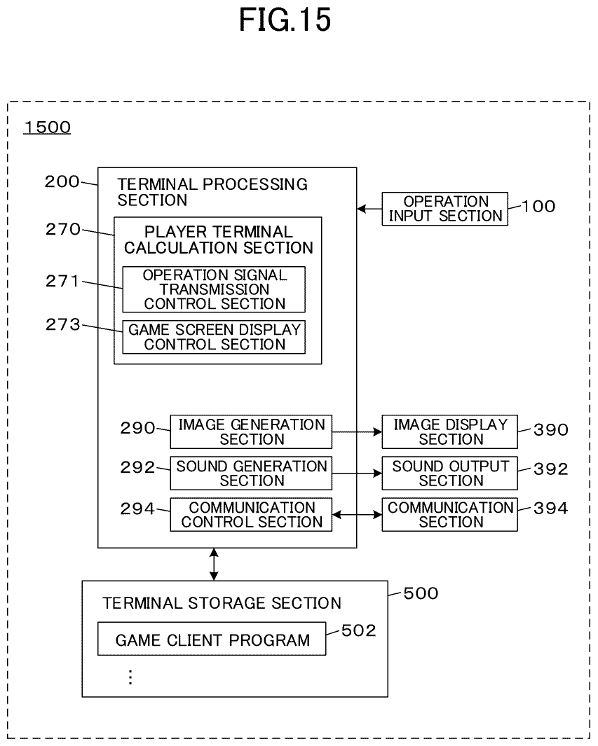

The distributed game client program 503 is an original of a game client program 502 (see FIG. 15) downloaded to the player terminal 1500.

The user management data 510 is prepared for each player who has registered as a user, and includes various types of data for management related to the gameplay of the player. Specifically, one piece of user management data 510 includes a player ID 511 of the corresponding player, a player level 513, and personal information 515 such as age and sex. The piece of user management data 510 may also include a play history such as a play date and time or a play time, saved data related to play status, or the like.

The game setting data 520 includes various types of setting data necessary for executing the game. For example, the game setting data 520 includes a type and various ability parameter values of each character in the candidate character group, model data, character setting data defining motion data or the like used for a motion control, object definition data related to various game objects such as an item that can be acquired by the player during a course of the game, stage setting data related to setting of a game stage, or the like.

The initial compatibility value table 540 stores an initial compatibility value of each character in the candidate character group with respect to each opponent character.

The display body definition data 530 includes the general value comparison data 531 (see FIG. 11) prepared for the general value list comparison display and including correspondence relations between the comparison values and the display bodies, the player-to-player comparison data 533 prepared for the player-to-player list comparison display and including correspondence relations between the player-to-player comparison values and the display bodies, and the initial value comparison data 535 prepared for the initial value list comparison display and including correspondence relations between the initial comparison values and the display bodies.

The match play data 570 is prepared for each game in progress, and includes various types of data describing players fighting in the game and play status (progress status) of the game.

The match information 580 is generated for each match, and includes the player IDs 591a and 591b, the used character types 595a and 595b, and the victory or defeat information 597a and 597b of the players in the match, as described referring to FIG. 3.

The match aggregation and analysis data 600 includes the general compatibility value table 610 (see FIG. 4), the individual compatibility value table 620 (see FIG. 5) for each player, and the comparison value table 630 (see FIG. 6) for each player.

The reward table 550 stores details of the reward to be given to a player in the reward giving control process. For example, when one of a plurality of rewards is given to a player, the reward table 550 includes a reward candidate list. When the details of the reward is variable according to the number of uncalculated individual compatibility values at a point of reward giving, the reward table 550 is prepared to include a list of rewards or a list of reward candidates to be given in association with the numbers of uncalculated individual compatibility values.

The effect data 560 is a data table defining details of effects to be implemented in the effect control process. Specifically, one piece of effect data 560 includes effect details 563 that are associated with a comparison value range 561 and are according to the comparison value range 561.

### 2. Player Terminal

FIG. 15 is a block diagram illustrating an example of a functional configuration of the player terminal 1500. As illustrated in FIG. 15, the player terminal 1500 includes an operation input section 100, a terminal processing section 200, an image display section 390, a sound output section 392, a communication section 394, and a terminal storage section 500.

The operation input section 100 is used by a player to input various operations, and can be implemented, for example, by a button switch, a joystick, a touch pad, a track ball, an accelerometer, a gyro sensor, or a charge coupled device (CCD) module. The operation input section 100 corresponds to the arrow key 1502, the home key 1504, and the touch panel 1506 illustrated in FIG. 2.

The terminal processing section 200 can be implemented, for example, by a processor including an arithmetic circuit such as a CPU, a GPU, an ASIC, or an FPGA, and an electronic component such as an IC memory. The terminal processing section 200 controls input/output of data between device sections including the operation input section 100 and the terminal storage section 500. The terminal processing section 200 performs various calculation processes based on a predetermined program, data, an operation input signal from the operation input section 100, and data received from the server system 1100 to integrally control the operation of the player terminal 1500. The terminal processing section 200 corresponds to the control board 1550 and the CPU 1551 thereon illustrated in FIG. 2. The terminal processing section 200 in accordance with the present embodiment includes a player terminal calculation section 270, an image generation section 290, a sound generation section 292, and a communication control section 294.

The player terminal calculation section 270 performs various calculation processes to cause the player terminal 1500 to function as a terminal for the gameplay of the player. For example, the player terminal calculation section 270 includes an operation signal transmission control section 271 and a game screen display control section 273.

The operation signal transmission control section 271 performs a process of transmitting various types of data and request information to the server system 1100 in accordance with an operation input performed on the operation input section 100.

The game screen display control section 273 performs a control for displaying a game screen based on various types of data received from the server system 1100. For example, when the online game in accordance with the present embodiment is implemented as a web game, the game screen display control section 273 can be implemented by a web technology that actively controls the screen display using Java (registered trademark) and cascading style sheets (CSS) along with a hypertext markup language (HTML) with a web browser as a base, such as a plugin of Adobe (registered trademark) Flash. Other methods may be employed, of course.

The image generation section 290 cooperates with the game screen display control section 273 to generate an image signal for displaying one game screen in every frame time (e.g., 1/60th of a second) based on the various types of data received from the server system 1100, and to output the generated image signal of the game screen to the image display section 390. For example, the image generation section 290 can be implemented, for example, by a processor such as a GPU or a DSP, a video signal IC, a program such as a video codec, or a drawing frame IC memory such as a frame buffer.

The sound generation section 292 is implemented, for example, by a processor such as a DSP or a sound synthesizing IC, or an audio codec for playing a sound file. The sound generation section 292 generates a sound signal for sound effects, BGM, and various types of operational sounds related to the game, and outputs the generated signal to the sound output section 392.

The communication control section 294 performs communication connection and data processing for data communication with an external device (e.g., the server system 1100) through the communication section 394, and implements exchange of data with the external device.

The image display section 390 displays various screens such as a game screen based on the image signals input from the image generation section 290. For example, the image display section 390 can be implemented by an image display device such as a flat panel display, a projector, or a head-mounted display. The image display section 390 corresponds to the touch panel 1506 illustrated in FIG. 2.

The sound output section 392 emits sounds such as sound effects and BGM related to the game, based on the sound signal input from the sound generation section 292. The sound output section 392 corresponds to the speaker 1510 illustrated in FIG. 2.

The communication section 394 connects to the network 9 to implement communication. For example, the communication section 394 can be implemented by a transceiver, a modem, a TA, a jack for wired communication cable, a control circuit, or the like. The communication section 394 corresponds to the wireless communication module 1553 illustrated in FIG. 2.

The terminal storage section 500 stores programs for causing the player terminal 1500 to operate to implement various functions included in the player terminal 1500 and data used during the execution of the programs. The programs and the data are stored previously or temporarily at every process. For example, the terminal storage section 500 can be implemented by an IC memory such as a RAM or a ROM, a magnetic disc such as a hard disc, or an optical disc such as a CD-ROM or a DVD. The terminal storage section 500 corresponds to the IC memory 1552 and the memory card 1540 illustrated in FIG. 2.

The terminal storage section 500 stores the game client program 502. The game client program 502 is a program for causing the terminal processing section 200 to function as the player terminal calculation section 270. The game client program 502 may be an exclusive client program or include a web browser program and a plugin that implements an interactive image display, depending on a technique and method for implementing an online game. In accordance with the present embodiment, the game client program 502 is a copy of the distributed game client program 503 (see FIG. 14) provided from the server system 1100.

### [Flow of Process]

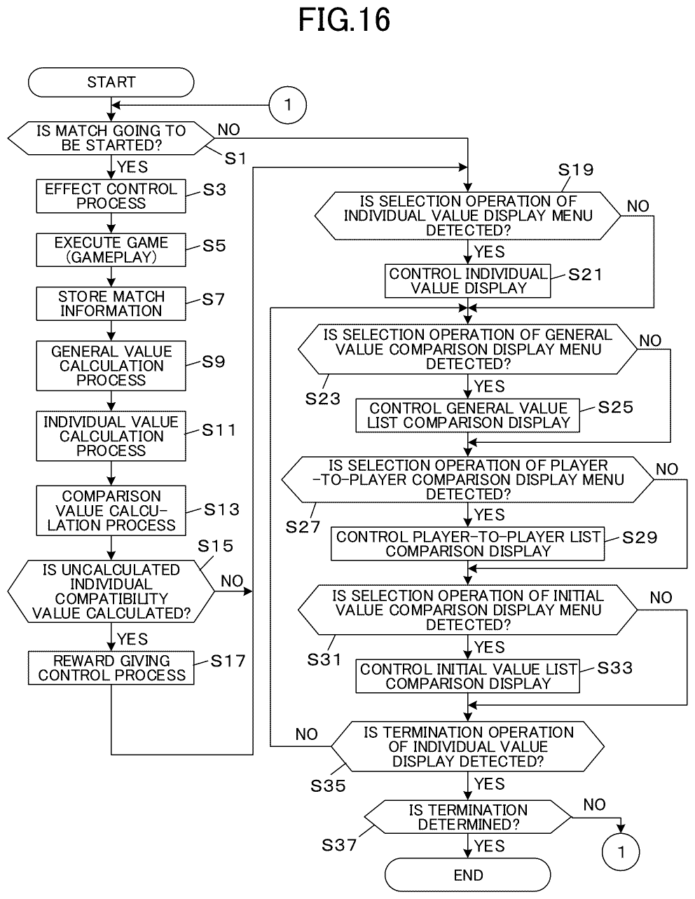

FIG. 16 is a flowchart illustrating a flow of processes of the server system 1100. This series of processes as described herein are implemented by the server processing section 200s reading out and executing the server program 501.

In the server system 1100, when there are players who are going to play a game, and a match is going to be started (step S1: YES), the effect control section 245 performs the effect control process to perform the control of implementation of an effect for each player on the player terminal 1500 of each player who is going to start the match (step S3). Specifically, the effect control section 245 performs the control of the implementation of the effect based on a comparison value of a used character of each player with respect to an opponent character on each player terminal 1500.

Then, the game progress control section 231 implements the game, and controls the progress of the gameplay on the player terminal 1500 of each player in the match (step S5). When the match ends, the match information 580 is generated and stored (step S7).

Then, the general value calculation section 233 performs the general value calculation process to reflect the match result of the latest match to the general compatibility value between the characters in the match (step S9). In addition, the individual value calculation section 235 performs the individual value calculation process to reflect the match result of the latest match to the individual compatibility values of the respective characters used by the first player and the second player with respect to the opponent characters in the match (step S11). Furthermore, the comparison value calculation section 237 performs the comparison value calculation process to calculate respective comparison values between the general compatibility value calculated in the step S9 and the individual compatibility values of the first player and the second player calculated in the step S11 (step S13).

Then, when an uncalculated individual compatibility value is calculated in the step S11 (step S15: YES), the reward giving control section 243 performs the reward giving control process to give a reward to a corresponding player (step S17).

When a selection operation of the individual value display menu by a player who has accessed the game site is detected (step S19: YES), the aggregation and analysis result display control section 239 controls the individual value display (step S21). Specifically, as described referring to FIG. 8, the aggregation and analysis result display control section 239 reads out the individual compatibility value of each character in the candidate character group with respect to each opponent character from the individual compatibility value table 620 to display in each cell in the matrix form.

Then, when a selection operation of the general value comparison display menu is detected during the control of the individual value display (step S23: YES), the comparison display control section 241 performs the control of the general value list comparison display (step S25).

When a selection operation of the player-to-player comparison display menu is detected during the control of the individual value display (step S27: YES), the comparison display control section 241 performs the control of the player-to-player list comparison display (step S29).

When a selection operation of the initial value comparison display menu is detected during the control of the individual value display (step S31: YES), the comparison display control section 241 performs the control of the initial value list comparison display (step S33).

Furthermore, when a termination operation of the individual value display is detected (step S35: YES), the individual value display is terminated. After this, unless termination of the series of processes is determined (step S37: NO), the processes return to the step S1 and the series of processes described above is repeated.

As described above, in accordance with the present embodiment, the general compatibility value between characters can be presented to the player in a comparable manner with respect to the individual compatibility value of the same combination of characters based on the match results of the matches performed by the first analysis target player. Furthermore, the individual compatibility value between characters based on the match results of the matches performed by the comparison target player can be presented to the player in a comparable manner with respect to the individual compatibility value of the same combination of characters based on the match results of the matches performed by the analysis target player. Furthermore, the initial compatibility value between characters can be presented to the player in a comparable manner with respect to the individual compatibility value of the same combination of characters based on the match results of the matches performed by the analysis target player.

The modes to which the present disclosure is applicable are not limited to the above-described embodiment, and the components can be added, omitted, or changed as appropriate.

### Modification Example 1

For example, in the embodiment described above, the effect based on the comparison result between the general compatibility value and the individual compatibility value is implemented before the players have a match in playing the game. However, the effect may be implemented after the match.

Furthermore, instead of the comparison result, an effect based on the general compatibility value or the individual compatibility value may be implemented. In these cases, effect data defining effect details based on possible values of the general compatibility values or the individual compatibility values may be prepared. For example, when an effect based on the general compatibility value is implemented in a situation illustrated in FIG. 12, an effect display according to the general compatibility value of the character 4a with respect to the character 4b is performed on the player terminal 1500 of the first player. On the other hand, an effect display according to the general compatibility value of the character 4b with respect to the character 4a is performed on the player terminal 1500 of the second player. Furthermore, when an effect based on the individual compatibility value is implemented in the situation illustrated in FIG. 12, an effect display according to the individual compatibility value of the character 4a with respect to the character 4b related to the first player is performed on the player terminal 1500 of the first player. On the other hand, an effect display according to the individual compatibility value of the character 4b with respect to the character 4a related to the second player is performed on the player terminal 1500 of the second player.

Alternatively, the effect implementation is not limited to before or after the gameplay by the players, and may be performed during a replay display of the game. In this case, the effect control section 245 controls the effect implementation during the replay display as a second effect control means. The effect itself may be performed in the same manner as described above based on any one of the general compatibility value, the individual compatibility value, and the comparison result (the comparison value) between the general compatibility value and the individual compatibility value.

### Modification Example 2

Furthermore, in the embodiments described above, the list comparison display is performed by displaying the display bodies in the cells in the matrix form displaying the individual compatibility values during the control of the individual value display. Specifically, the display bodies according to the comparison values are displayed in the general value list comparison display, the display bodies according to the player-to-player comparison values are displayed in the player-to-player list comparison display, and the display bodies according to the initial comparison values are displayed in the initial value list comparison display. However, the list comparison display of these types may be performed by changing a display mode of each cell according to the comparison value, the player-to-player comparison value, or the initial comparison value. For example, a display color of the individual compatibility value in each cell may be made to correspond to the comparison value of the same combination of characters as that of the cell, or a background color of each cell may be made to correspond to the comparison value of the same combination of characters as that of the cell.

### Modification Example 3

Furthermore, in the embodiments described above, the general compatibility value is calculated by aggregating the match information 580 of the matches performed by all the registered users. However, the general compatibility value may be calculated by selecting and aggregating the match information 580 of the matches performed by predetermined aggregation target players. For example, the aggregation target players may be members of a group that the analysis target player belongs to, and the general compatibility value may be calculated from the match information 580 of the matches performed by the respective members.

Although only some embodiments of the present disclosure have been described in detail above, those skilled in the art will readily appreciate that many modifications are possible in the embodiments without materially departing from the novel teachings and advantages of this disclosure. Accordingly, all such modifications are intended to be included within scope of this disclosure.

What is claimed is:

1. A computer system comprising:
at least one processor or circuit programmed to:
store match information including types of characters used in matches and a match result for each match;
calculate an index value indicating match compatibility between characters as a general compatibility value for each combination of characters based on the match information;
calculate an index value indicating match compatibility between characters as an individual compatibility value for each combination of a character used by a first analysis target player in one of the matches and a character used as an opponent of the character based on the match information on each match performed by the first analysis target player, by:
aggregating and analyzing the match information on each match performed by the first analysis target player; and
calculating an individual compatibility value based on a piece of match information that meets a predetermined aggregation target condition by a result of the aggregation and analysis;
perform a control of a list comparison display that compares the general compatibility value and the individual compatibility value of a same combination of characters, by:
performing a control of a list comparison display using a matrix form divided for each combination of characters; and
performing a display control representing that the individual compatibility value is not calculated yet on a part of the matrix form corresponding to a combination of characters that does not meet the predetermined aggregation target condition and whose individual compatibility value is not calculated yet; and
perform a control of giving a given reward to the first analysis target player when the individual compatibility value is calculated by new match information due to a new match being performed in relation to the combination of characters whose individual compatibility value is not calculated.

2. The computer system as defined in claim 1, wherein the aggregation target condition includes at least that a number of matches performed with the same combination of the character used by the first analysis target player and the character used as the opponent meets a predetermined smallest match number condition.

3. The computer system as defined in claim 1, wherein the aggregation target condition includes at least that an index value indicating strength set to the opponent meets a predetermined lowest condition.

4. The computer system as defined in claim 1, wherein the control of the list comparison display includes performing a control of displaying the individual compatibility value and the general compatibility value together.

5. The computer system as defined in claim 1, wherein
calculation of the individual compatibility value includes calculating an individual compatibility value of a second analysis target player based on the match information on each match performed by the second analysis target player, and
the control of the list comparison display includes performing a control of a list comparison display that compares the individual compatibility value of the first analysis target player and the individual compatibility value of the second analysis target player.

6. The computer system as defined in claim 1, wherein the control of the list comparison display includes performing a control of a list comparison display using cells formed in a matrix form divided for each combination of characters.

7. The computer system as defined in claim 6, wherein the control of the list comparison display includes performing a control of displaying a display body according to a comparison result between the general compatibility value and the individual compatibility value in a superimposing manner in each cell.

8. The computer system as defined in claim 6, wherein the control of the list comparison display includes performing a control of variably displaying a display mode of each cell according to a comparison result between the general compatibility value and the individual compatibility value.

9. The computer system as defined in claim 6, wherein the control of the list comparison display includes variably setting a display order of the cells in the matrix form based on a given display order rule.

10. The computer system as defined in claim 1, wherein the at least one processor or circuit is further programmed to
perform a control of implementing an effect based on any one of the general compatibility value, the individual compatibility value, and a comparison result between the general compatibility value and the individual compatibility value before or after the first analysis target player has a match in playing a game.

11. The computer system as defined in claim 1, wherein the at least one processor or circuit is further programmed to
perform a control of implementing an effect based on any one of the general compatibility value, the individual compatibility value, and a comparison result between the general compatibility value and the individual compatibility value during a replay display of a game played by the first analysis target player.

12. A computer system comprising:
at least one processor or circuit programmed to:
store match information including types of characters used in matches and a match result for each match;
calculate an index value indicating match compatibility between characters as an individual compatibility value for each combination of a character used by an analysis target player in one of the matches and a character used as an opponent of the character based on the match information on each match performed by the analysis target player, by:
aggregating and analyzing the match information on each match performed by the first analysis target player; and
calculating an individual compatibility value based on a piece of match information that meets a predetermined aggregation target condition by a result of the aggregation and analysis;
perform a control of a list comparison display that compares an initial compatibility value and a corresponding individual compatibility value of a same combination of characters, by:
performing a control of a list comparison display using a matrix form divided for each combination of characters; and
performing a display control representing that the individual compatibility value is not calculated yet on a part of the matrix form corresponding to a combination of characters that does not meet the predetermined aggregation target condition and whose individual compatibility value is not calculated yet; and
perform a control of giving a given reward to the first analysis target player when the individual compatibility value is calculated by new match information due to a new match being performed in relation to the combination of characters whose individual compatibility value is not calculated.

13. A game system comprising:
a player terminal of each player; and
a server system that is the computer system as defined in claim 1 and is communicably connected to each player terminal.

14. A game system comprising:
a player terminal of each player; and
a server system that is the computer system as defined in claim 12 and is communicably connected to each player terminal.
